(19) United States
(12) Patent Application Publication
(10) Pub. No.: US 2020/0002093 A1
(43) Pub. Date: Jan. 2, 2020

(54) Systems and Methods for Object Storage and Retrieval

(71) Applicant: Walmart Apollo, LLC, Bentonville, AR (US)

(72) Inventors: David G. Tovey, Rogers, AR (US); Boyd Dean Bryant, Bella Vista, AR (US); Robert Michael Armstrong, Rogers, AR (US); Kurt William Robert Bessel, Mexico, NY (US); Jason Bellar, Bella Vista, AR (US)

(21) Appl. No.: 16/454,961

(22) Filed: Jun. 27, 2019

Related U.S. Application Data
(60) Provisional application No. 62/690,579, filed on Jun. 27, 2018.

(51) Int. Cl. B65G 1/137; B65G 43/08

(52) U.S. Cl. CPC B65G 1/1371; B65G 43/08

(57) ABSTRACT

Described in detail herein is an autonomous object storage and retrieval system. A tray can support one or more physical objects. One or more adjustable members coupled to the tray can transition from a first state to a second state based on the one or more physical objects disposed on the tray. The one or more adjustable members stabilize the one or more physical objects when the one or more adjustable members are in the second state. A transport apparatus can transport the tray with the physical object. The one or more adjustable members are in the second state as the transport apparatus transports the tray between the at least one of the plurality of shelves and the receptacle.

### RELATED APPLICATIONS

This application claims priority to and the benefit of U.S. Provisional Application No. 62/690,579, filed on Jun. 27, 2018, the content of which is incorporated by reference herein in its entirety.

### BACKGROUND

Physical objects can shift, tip over, or otherwise be unstable when being stored and/or retrieved from object storage and retrieval system. This can result in damage to the objects, spills or leaking of contents from the objects, and other undesirable consequences.

### BRIEF DESCRIPTION OF DRAWINGS

Illustrative embodiments are shown by way of example in the accompanying drawings and should not be considered as a limitation of the present disclosure:

FIG. 1 is a schematic diagram of a storage receptacle in an storage tower in accordance with exemplary embodiments;

FIG. 2 is a schematic diagram of an exemplary storage tower in accordance with an exemplary embodiment;

FIG. 3 is a schematic diagram of an interior of a storage tower in accordance with an exemplary embodiment;

FIG. 4 is a schematic diagram of an exterior of an embodiment of the storage tower in accordance with an exemplary embodiment.

FIGS. 5-8 are schematic diagrams illustrating a tray and adjustable members disposed on the tray according to exemplary embodiments;

FIG. 9 is a block diagram illustrating an autonomous object storage and retrieval system in accordance with an exemplary embodiment;

FIG. 10 is a block diagram illustrating of an exemplary computing device in accordance with an exemplary embodiment;

FIG. 11 is a flowchart illustrating an exemplary process in accordance with an exemplary embodiment; and

FIG. 12 is a flowchart illustrating an exemplary process in accordance with an exemplary embodiment.

### DETAILED DESCRIPTION

Described in detail herein is an autonomous object storage and retrieval system and object stabilization apparatus for the autonomous object storage and retrieval system. The stabilization apparatus can include a tray and one or more adjustable member. The tray can support one or more physical objects. The one or more adjustable members can be operatively coupled to or integrally formed with the tray, and can transition from a first state to a second state to stabilize the one or more physical objects disposed on the tray. A transport apparatus can transport the tray with the physical object from a receptacle of storage tower to a shelf in the storage tower system to store the tray on the shelf in the storage tower, or can transport the tray from the a shelf in the storage tower to the receptacle to output the one or more physical objects. The one or more adjustable members can be in the second state as the transport apparatus transports the tray between the shelves and the receptacle.

An actuator can control the adjustable member to facilitate transition from the first state to the second state and/or from the second state to the first state. A computing system can be in communication with a database and a controller. The controller can be the operatively coupled to the actuator. The computing system can receive a notification associated with a request to store the one or more physical objects in the autonomous storage and retrieval system. The computing system can query the database to retrieve characteristics associated with the one or more physical objects. The computing system can determine, based on the characteristics, that the one or more physical objects is susceptible of shifting, tipping, leaking, or otherwise may be unstable. The computing system can instruct the controller to actuate the one or more adjustable members from the first state to the second state to stabilize the one or more physical objects on the tray in response to the one or more physical objects being disposed on the tray.

In exemplary embodiments, the one or more adjustable members is an inflatable bladder and the actuator is an air compressor or pump. The first state corresponds to the inflatable bladder in a deflated state and the second state corresponds to the inflatable bladder being inflated.

In exemplary embodiments, the one or more adjustable members includes an adjustable wall and the actuator comprises an arm or shaft configured to move the adjustable wall laterally to engage the one or more physical objects when the one or more physical objects are disposed on the tray. The controller can control the actuator to move the adjustable wall laterally toward the physical object on the tray to clamp the one or more physical objects in a stable position, in response to receiving the instruction from the computing system to control the adjustable members.

In exemplary embodiments, an electromagnetic element can be included in the one or more adjustable members. The electromagnetic element can be disposed on, under, or in a surface of the tray, and can be selectively controlled to generate, a magnetic field in response to receiving an electric current. A ferromagnetic material can be operatively coupled to the one or more physical objects. The actuator can provide an electric current to the electromagnetic element to generate a magnetic field around the physical object, in response to receiving the instruction from the computing system to control the adjustable members. The ferromagnetic material can be attracted to the electromagnetic element by a magnetic force that stabilizes the physical object.

In exemplary embodiments, the one or more adjustable members can include a plurality of spring loaded pins disposed on the tray. The first state corresponds to the plurality of spring loaded pins protruding into an area of the tray configured to receive the one or more physical objects. The second state corresponds to at least some of the plurality of spring loaded pins can be urged to a retracted state prior in response to an interaction with the one or more physical objects when the one or more physical objects are placed on the tray. For example, the weight of the physical object can exert a force of the some of the pins to compress the springs associated with the pins.

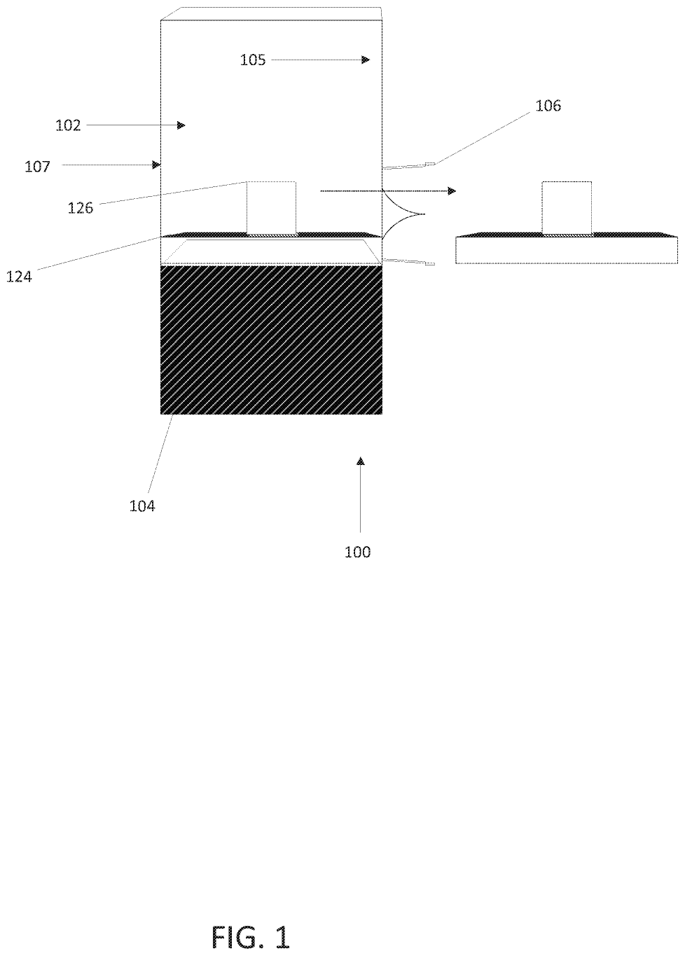

FIG. 1 is a block diagram of a storage receptacle 100 in a storage tower in accordance with exemplary embodiments. One or more storage receptacles 100 can be disposed in the storage tower at different locations as described herein. For example, the storage receptacle 100 can be disposed in a front, a first side, or a second side of the storage tower. The storage receptacle 100 can include an interior storage volume 102 and a base 104 within the interior storage volume 102. The base 104 can support a tray 124, which can support a physical object 126. A first (front) side 105 of the storage receptacle 100 can include a door 106. A second (back) side 107 of the storage receptacle 100 can be an open face. The storage receptacle 100 can be configured to receive and eject the tray 124 and physical object 126 from the door 106 on the front side and through the open face of the back side 107. The door 106 can be a sliding door (sliding horizontally or vertically), a rotating door, a hinged door, and/or a double door.

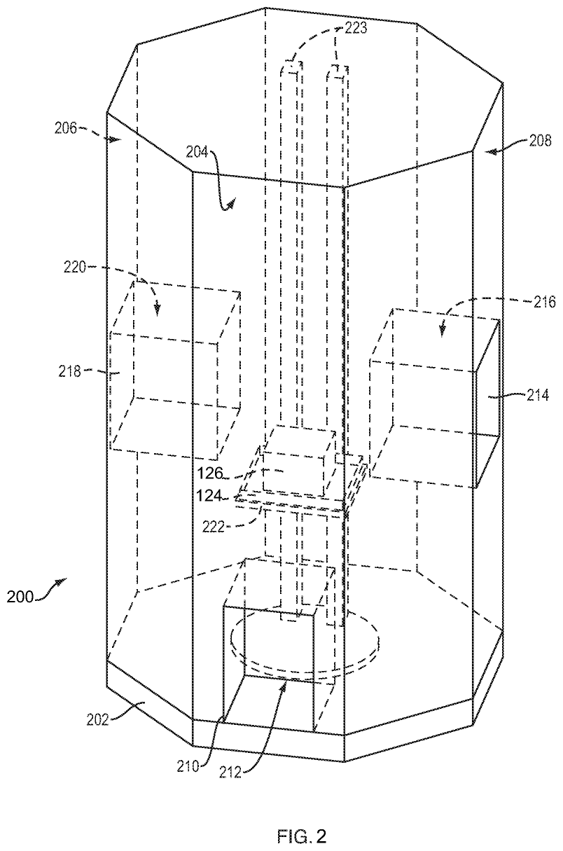

FIG. 2 is a block diagram of an exemplary storage tower 200 in accordance with an exemplary embodiment. The storage tower 200 can include housing having a base 202 coupled to side walls or surfaces extending from the base 202. In the present example, the side walls or surfaces of the storage tower 200 can form octagonal cylinder or column such that there are eight side walls or surfaces including a front face 204, a first side face 206, and a second side face 208. A front opening 210 can be disposed on the front face 204. A first side opening 218 can be disposed on the first side face 206. A second side opening can be disposed on the second side face 208. It can be appreciated that the openings, front opening 210, first side opening 218, and second side openings 214, can have retractable doors, windows, or panels to selective cover the openings 210, 214, and 218.

The interior of the storage tower 200 can include a loader 222 coupled to shafts or railings 223. The loader 222 can be configured to transport and support the tray 124, which is configured to support physical objects (e.g., the physical object 126). The loader 222 is further configured to move along the railings 223 along the y-axis. The interior of the storage tower 200 can further include a front storage receptacle 212 aligned with and/or coupled to the front opening 210. A first side storage receptacle 220 can be aligned with and/or coupled to the first side opening 218. A second side storage receptacle 216 can be aligned with and/or coupled to the second side openings 214. The front storage receptacle 212, first side storage receptacle 220, and second side storage receptacle 216 can include a storage volume, configured to store objects, such as the tray 124 and the physical object 126. The front opening 210, first side opening 218, and second side openings 214 can provide access to the storage volume of the front storage receptacle 212, first side storage receptacle 220, and second side storage receptacle 216. In exemplary embodiments, the storage receptacles 212, 216, and 220 can be formed by an embodiment of the storage receptacle (e.g., storage volume 100 as shown in FIG. 1).

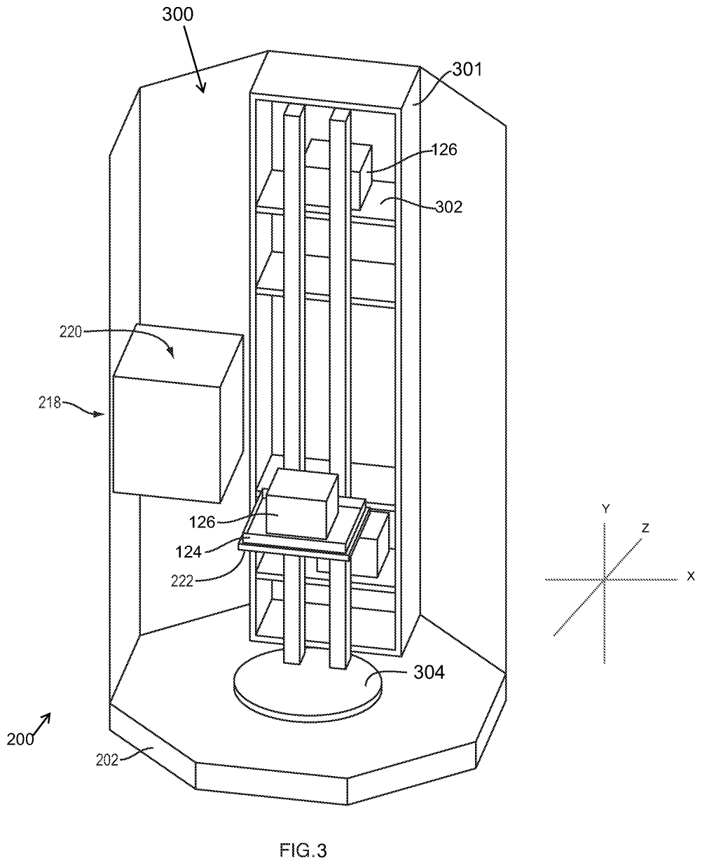

FIG. 3 is a schematic diagram of an interior of a storage tower 200 in accordance with an exemplary embodiment. The interior of the storage tower 200 can include eight interior walls 300 defined by the side walls or surfaces of the housing. The interior of the storage tower 200 can include a shelving unit 301, the loader 222, the railings 223, and a rotating base 304. The railings 223 can be coupled to the rotating base 304. The loader 222 can be configured to support and transport the tray 224 between a shelf on the shelving unit and one of the storage receptacles. The tray 224 can support the physical object 126. The loader 222 can be coupled to the railings 223. The loader 222 can extend perpendicularly from the railings 223. As an example, the loader 222 can be a pallet. The railings 223 can operate as a boom to lower and raise the loader 222. The rotating base 304 can rotate the railings 223, and therefore, the loader 222 360 degrees about a center axis of the rotating base.

The shelving unit 301 can include shelves 302 configured to store and support physical objects 226. The shelving unit 301 can be disposed along one or more of the interior walls 300 of the storage tower 200. For example, the shelving units 301 can be disposed along one interior wall, each interior wall or a subset of the interior walls of the storage tower 300.

As an example, the loader 222 can receive instructions to load a physical object 126 from the shelving unit 301, onto the loader 222, and load the physical object 226 into a first side receptacle 220. The rotating base 304 can be configured to rotate the railings 223 circumferentially around the interior of the storage tower 200 so that the railings 223 are parallel to the appropriate shelving unit 301. The loader 222 can vertically move up and down the railings 223 to align itself with the shelf 302 on which the requested physical object 126 is disposed.

The loader 222 can pick up the tray 124 supporting the physical object 126. The loader 222 can traverse along and rotate about the railings 223, transport and deposit the tray 124 and physical object 126 in the first side receptacle 220. The physical object 126 can be stored in the first side receptacle 220, until ejected from the first side opening 218.

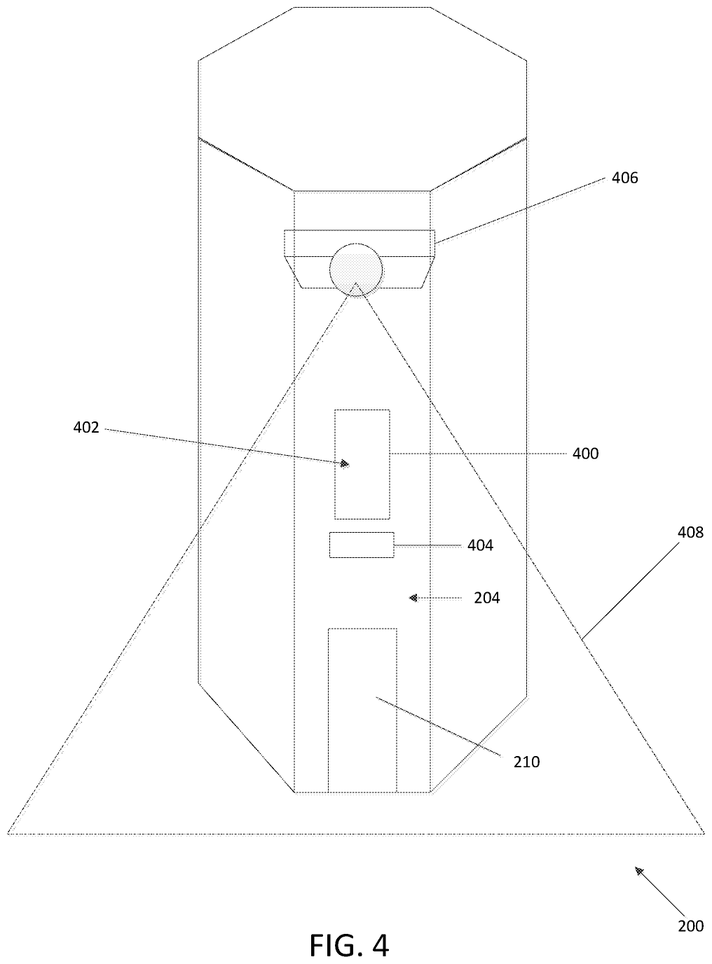

FIG. 4 is a schematic diagram of an exterior of an embodiment of the storage tower 200 in accordance with an exemplary embodiment. An interactive display 400 can be disposed on the storage tower 200. The interactive display 400 can be disposed on the front surface 204 with respect to the front opening. An input device 404 can also be disposed on the storage tower. The input device 404 can be disposed on the front surface 204 with respect to the front opening 210. The input device 404 can be one or more of, an optical scanner, a keyboard/keypad, and image capturing device.

The interactive display 400 can render a graphical user interface (GUI) 402. The GUI 402 can display information associated with a request for dispensing a physical object through the front opening of the storage tower. As an example, a user can input information associated with a request for dispensing a physical object. The information can be an identifier, a name, a username, a pin number or any suitable information that can be used to identify the physical object to be retrieved or stored. As a non-limiting example, the user can enter the information, via a touchscreen display incorporated in the interactive display 402. Alternatively, or in addition to, the interactive display 402 can have multiple input devices such as a keyboard, mouse, joystick, touchpad, or other devices configured to interact with the interactive display 402, such as the input device 404. The user can input identification information using the input device 404

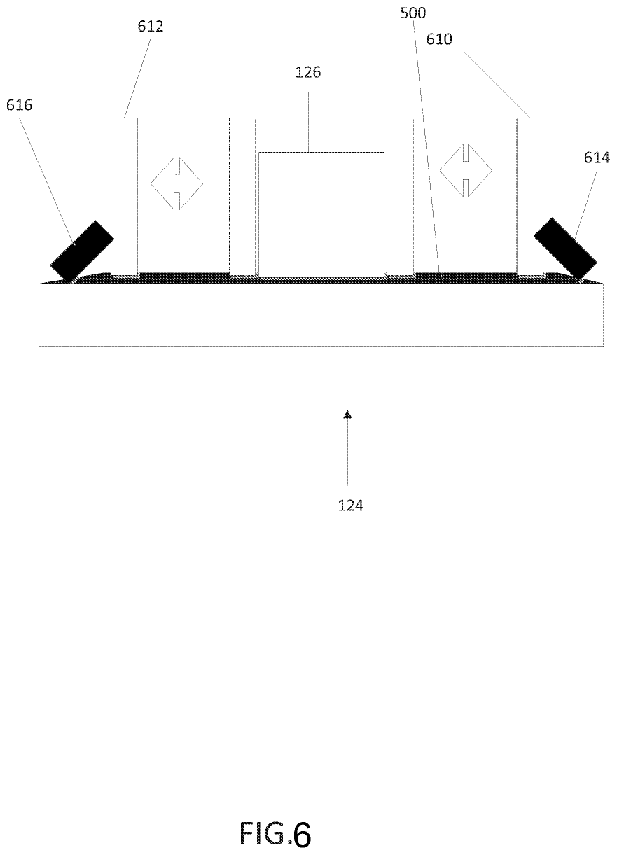

The user can also scan a machine-readable element encoded with an identifier associated with the physical object, using the input device 404. As an example, the input device 404 can be an optical scanner or an image capturing device. The input device 404 can scan/capture and decode the identifier from the machine-readable element. The machine-readable element can be a barcode or a QR code. The input device 404 can transmit the identifier to the interactive display. The interactive display 400 can receive the information associated with the request and transmit the information to a computing system. The computing system will be described in greater detail with respect to FIG. 6.

In one embodiment, a motion sensor 406 can be disposed on the front surface 204 of the storage tower 200. The motion sensor can detect a user approaching the storage tower 200, within a given radius 408. The doors of the front opening 210 can automatically open in response to the motion sensor 406 detecting a user approaching the storage tower 200. Alternatively, or in addition to, the interactive display 402 can be powered down (in energy saving mode) and in response to the motion sensor detecting a user entering the radius 408, the interactive display 402 can be powered on.

In one embodiment, the user can request to dispense a physical object, disposed in the storage tower 200 or another storage tower. The user can input identification information associated with the using the interactive display 400 and/or input device 404. The identification information can be transmitted to the computing system. The computing system can instruct the storage tower 200 in which the physical object is disposed to dispense the physical object. In the event the physical object is disposed in the storage tower 200, the storage tower 200 can dispense the physical object through the front opening 210 of the storage tower 200.

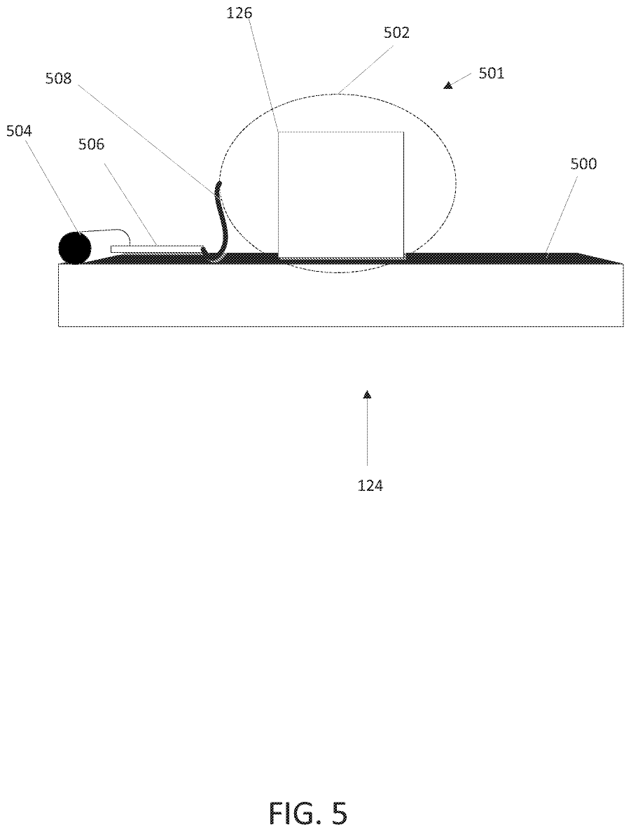

FIGS. 5-8 are schematic diagrams illustrating a stabilizing apparatus including an embodiment of the tray 124 and adjustable members operatively coupled to the tray 124 according to exemplary embodiments. With respect to FIG. 5, the adjustable members can be an inflatable bladder 501. The inflatable bladder 501 can include a sack (or bag) 502, an air compressor or pump 504, a chamber 506, and tubing 508. The air compressor 504 can be the actuator of the airbladder 501. The air compressor 504 can be electrically powered. The sack 502 can be disposed to surround the physical object 126 and can be made of flexible material such as a polymer (e.g., rubber or plastic). As an example, the sack 502 can extend about a perimeter of the tray 124 such that when the sack 502 is inflated it expands laterally inward from the perimeter of the tray 124 towards the physical object disposed on the tray 124. The chamber 506 can be coupled to the air compressor 504 and to the tubing 508. The tubing 508 can be coupled to the sack 502.

In a first state, the inflatable bladder 501 can be deflated. In response to receiving instructions (e.g., from a controller), the air compressor 504 can dispense air, liquid or gas through the chamber 506 and tubing 508 into the sack 502. The instructions can be generated in response to determining that a physical object has been placed on the tray. In response to receiving the air, liquid or gas, the sack 502 can be inflated to a specified pressure as the inflatable bladder 501 transitions to a second (inflated) state. The specified pressure can depend on the size of the physical object. As an example, the sack 502 can be inflated to press against the physical object 126. The inflated sack 502 can prevent the physical object from shifting, tipping over, breaking, moving, or from otherwise being unstable while the tray 124 is in motion (e.g., being transported to or from a shelf in a storage tower).

With reference to FIG. 6, the adjustable members can be adjustable walls 610, 612. The adjustable walls 610, 612 can be connected to support members 614, 616, respectively. The support members 614, 616 can be actuators to move the adjustable walls 610. The adjustable walls 610, 612 can be disposed on the surface 500 of the tray 124. In a first state the adjustable walls 610, 612 can be disposed away from the physical object 126 in a retracted position. In response to receiving instructions (e.g., from a controller), the support members 614, 616 can push or urge the adjustable walls 610, 612 laterally along the surface 500 to clamp the physical object 126 in place. The instructions can be generated in response to determining that a physical object has been placed on the tray. The adjustable walls 610, 612 can be in a second state (e.g., a protracted position) while clamping the physical objects in place. While in the second state, the adjustable walls can prevent the physical object 126 from shifting, tipping over, breaking, moving, or from otherwise being unstable while the tray 124 is in motion (e.g., being transported to or from a shelf in a storage tower). In one embodiment, the adjustable walls can be controlled to extend a specified distance laterally in the protracted position, so that the adjustable walls 610, 612 remain within a specified proximity to the physical object 126. Alternatively, or in addition to, the adjustable walls 610, 612 can detect the physical object is within a specified proximity or that the walls 610, 612 are in contact with the physical object.

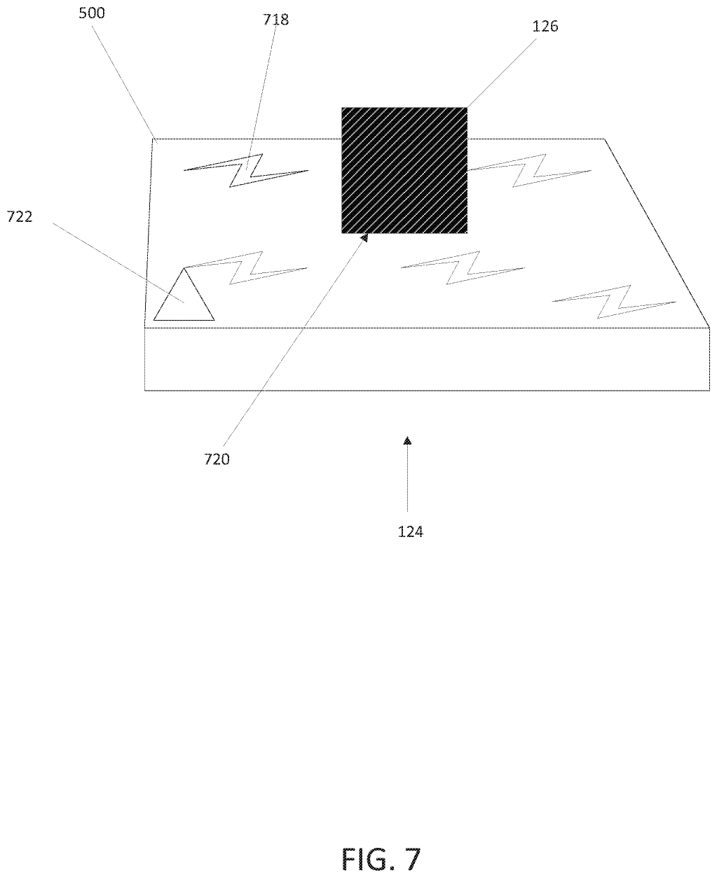

With reference to FIG. 7, the adjustable members can be electromagnetic elements 718 disposed on, under, or in the surface 500 of the tray 124. The electromagnetic elements 718 can be configured to generate a magnetic field in response to receiving an electric current. The actuator 722 can include for example a switched power supply to provide the electric current to the electromagnetic elements 718. As an example, the electromagnetic elements 718 can be a wire disposed in a loop on the surface 700 of the tray 124. The wire can be coupled to a switch which can act as an actuator 722 to provide electrical current to the wire.

The physical object 126 disposed on the tray 124 can be made of or can include a ferromagnetic material 720. In response, to the actuator 722 providing an electrical current to the electromagnetic elements 718, a magnetic field can be generated around the physical object 126. The force of the magnetic field can interact with the ferromagnetic material 720 of physical object 126, so that physical object 126 maintains its position on the tray 124. The physical object 126, can be stabilized on the tray and prevent the physical object from shifting, tipping over, breaking, moving, or from otherwise being unstable while the tray 124 is in motion.

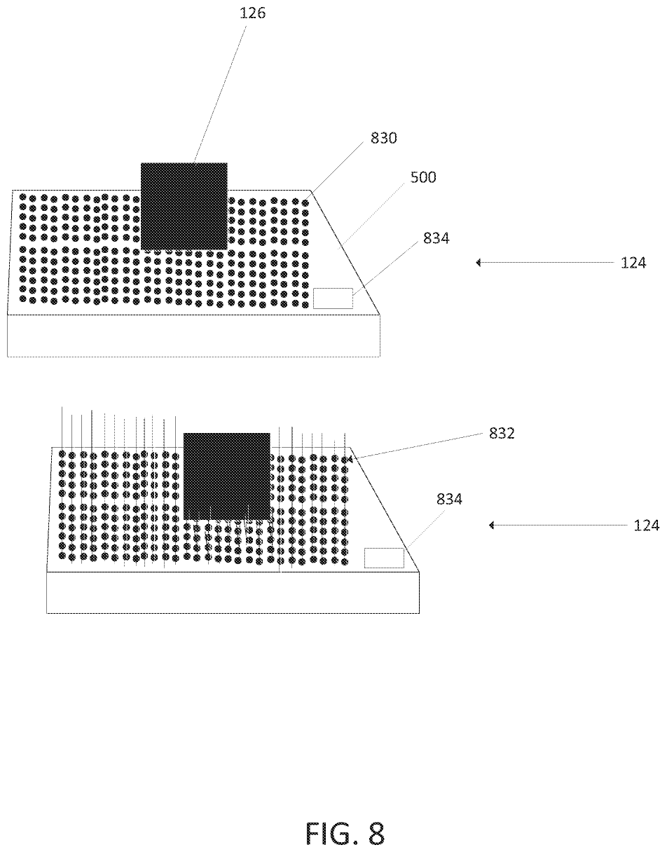

With reference to FIG. 8, the adjustable members can be spring loaded pins 832. Apertures 830 disposed on the surface of the tray 124, can be loaded with spring loaded pins 832 and disposed on the surface 500 of the tray 124. In one embodiment, the spring loaded pins 832 can be retracted within inside of the tray 124. An actuator 834 can be electrically coupled to the spring loaded pins. In response to receiving instructions, the actuator can extend the spring loaded pins 832 through the apertures 830. The extended springs loaded pins 832 can surround the physical object 126, while the spring loaded pins 832 disposed underneath the physical object 126 can remain retracted or partially extended.

In another embodiment, all of the spring loaded pins 832 can be fully extended through the apertures 830. In response to the surface 500 of the tray 124 receiving the physical object 126, the spring loaded pins 832 disposed underneath the physical object 126 can retract or remain only partially extended. The spring loaded pins 832 disposed underneath the physical object 126 can remain retracted or partially extended due to the force caused by the weight of the physical object 126.

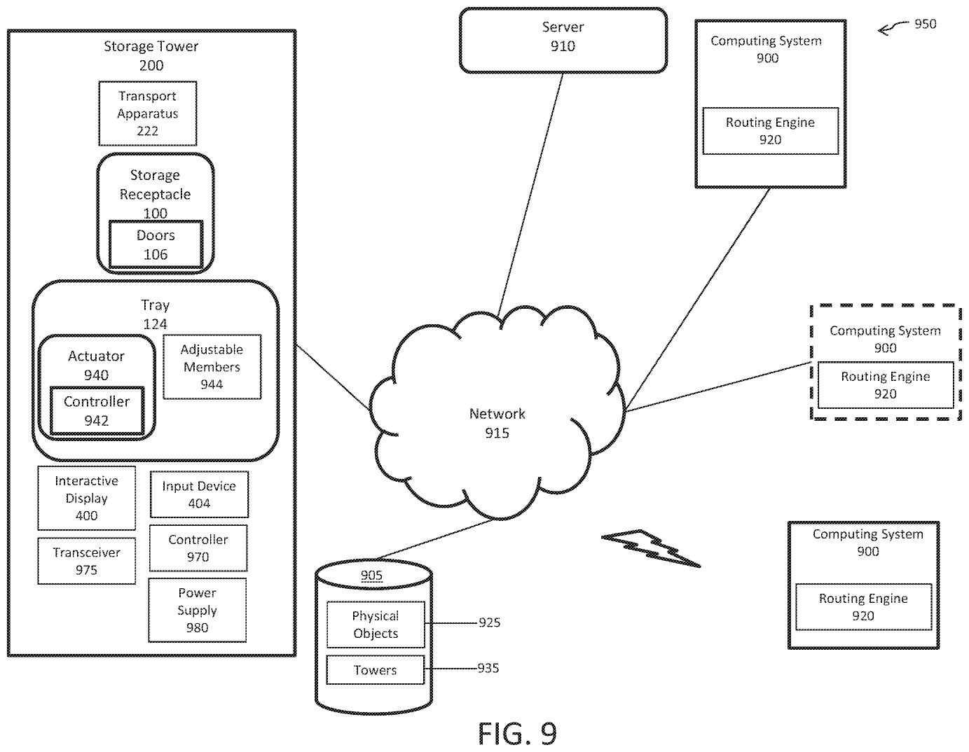

FIG. 9 illustrates an exemplary autonomous object storage and retrieval system 950 in accordance with an exemplary embodiment. The autonomous object storage and retrieval system 950 can include one or more databases 905, one or more servers 910, one or more computing systems 900, and one or more storage towers 200. Each of the storage towers 200 can include a transport apparatus 222, one or more receptacles 200 and a tray 124. The tray 124 can include adjustable members 944 operatively coupled to an actuator 940. The actuator 940 can be coupled to a controller 942. The computing system 900 can include a routing engine 920. The routing engine 920 can implement the autonomous object storage and retrieval system 950.

In an example embodiment, one or more portions of the communications network 915 can be an ad hoc network, a mesh network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a Wi-Fi network, a WiMAX network, any other type of network, or a combination of two or more such networks.

The server 910 includes one or more computers or processors configured to communicate with the computing system 900, the databases 905, storage towers 200, via a communications network 915. The server 910 hosts one or more applications configured to interact with one or more components computing system 900 and/or facilitates access to the content of the databases 905. The databases 905 may store information/data, as described herein. For example, the databases 905 can include physical objects database 925 and a towers database 935. The physical objects database 925 can store information associated with physical objects. The towers database 935 can store information associated with the storage towers location and physical object disposed in the storage towers. The databases 905 can be located at one or more geographically distributed locations from the computing system 900. Alternatively, the databases 905 can be located at the same geographically as the computing system 900.

The storage towers 200 can include one or more storage receptacles 100, a transport apparatus 222, a tray 124 including an actuator 940 and adjustable members 944, an interactive display 400, an input device 404, a controller 970, and a transceiver 975. The one or more storage receptacles 100 can include a door 106. The actuator 940 can include a controller 942, configured to control the operations of the actuator 940. The storage towers 200 can also be coupled to a power source 980. The power source 980 can provide power to the transport apparatus 222, door 106, actuator 940, controller 942 adjustable members 944, interactive display 400, input device 404, controller 970, and transceiver 975. The transceiver 975 can transmit and receive data, via the network 915. The controller 970 can control the operations of transport apparatus 222, door 106, interactive display 400, and input device 404, based on received data from the transceiver 975.

In an exemplary embodiment, one or more storage towers 200 can be disposed in a facility. Physical objects can be disposed in the storage towers 200. A user can request a physical object to be dispensed at storage tower 200 and/or to be stored in the storage tower 200. The user can input identification information associated with the physical object at the interactive display 400 and/or input device 404. The controller 970 of storage tower 200 can receive the identification information and transmit, via the transceiver 975, the identification information associated with the physical object to the computing system 900.

The computing system 900 can receive the identification information associated with the physical object and execute the routing application 920. The routing application 920 can query the physical objects database 925 to retrieve information associated with the physical object. The information can include, name of physical object, type of physical object, size of physical object, the materials comprised in the physical object and other information associated with the physical object. The routing application 920 can query the towers database 935 to retrieve information associated with the storage tower in which the physical object is disposed and a location within the storage tower 900 where the physical object is disposed.

The routing engine 920 can determine the characteristics of the materials making up the physical object are susceptible to leaking from the one or more physical objects. For example, the materials can be liquid, gas, or powder/granular. The routing engine 920 can transmit instructions the storage tower 200, to dispense and/or receive the physical object. In response to the transceiver 975 of the storage tower 200, receiving the instructions, the controller 970 can control the transport apparatus 222 to navigate to the location of the physical object within the storage tower 200, and pick-up the tray 124 supporting the physical object. The transport apparatus 222 can pick up the tray 124 from the receptacle 300. In response to picking up the tray 124, controller 970 can instruct the controller 942 to control the actuator 940 to actuate the adjustable members 944 from the first state to the second state to stabilize the one or more physical objects on the tray 124, while the tray 124 is in motion. The adjustable members 944 can maintain the position of the physical object to keep the physical object from shifting, tipping over, leaking, breaking, or from otherwise being unstable. As described herein, the adjustable members 944 can include an airbladder, moveable walls, electromagnetic elements, and/or spring loaded pins. The transport apparatus 222 can deposit the tray 124 in the storage receptacle 100. Alternatively, the transport apparatus 222 can deposit the tray 124 on a shelving unit within the storage tower 200.

As a non-limiting example, the autonomous storage and retrieval system 950 can be implemented in a retail store. The storage towers 200 can be disposed at the retail store. The physical object can be products purchased or about to be purchased by users from the retail store. The products can include materials with characteristics which are susceptible to leaking from the one or more physical objects.

The user can be a customer of the retail store and can pick-up products from the storage towers 200. As an example, the user can purchase something online and pick-up the product from the storage tower 200. Alternatively, or in addition to, the user can use the interactive display 400 of the storage towers 200 and/or a Point-of-Sale (POS) terminal of the retail store to purchase a product and pick-up the product from the storage towers 200. As described above, the user can request the physical object from any of the storage towers 200.

A user can input identification information associated with a product at the interactive display 400 or input device 404 of the storage tower 200. The identification information can be a machine-readable element such as a barcode and/or QR code printed on a receipt or rendered on a mobile device display. The machine-readable element can be encoded with an identifier associated with the product. The input device 404 can be an optical scanner and/or image capturing device configured to scan and decode the identifier from the machine-readable element. In addition to, or alternatively, the user can input the identifier of the product using the interactive display 400 (i.e. a touch screen display) and/or the input device 404 (i.e. a keyboard/touchpad).

The controller 970 of the storage tower 200 can transmit, via the transceiver 975, the identifier of the product to the computing system 900. The routing engine 920 can determine the characteristics of the materials of the product are susceptible to leaking from the product. The routing engine 920 can transmit instructions to the storage tower 200 to dispense the product from the storage tower 100. In response to the transceiver receiving the instructions, the controller 970, can control the transport apparatus 222 can navigate to the location of the product within the storage tower 200, and pick-up the tray 124 on which the product is disposed. In response to picking up the tray 124, the controller 970 can instruct the controller 942, to control the actuator 940 to actuate the adjustable members 944 from the first state to the second state to stabilize the one or more physical objects on the tray 124, while the tray 124 is in motion.

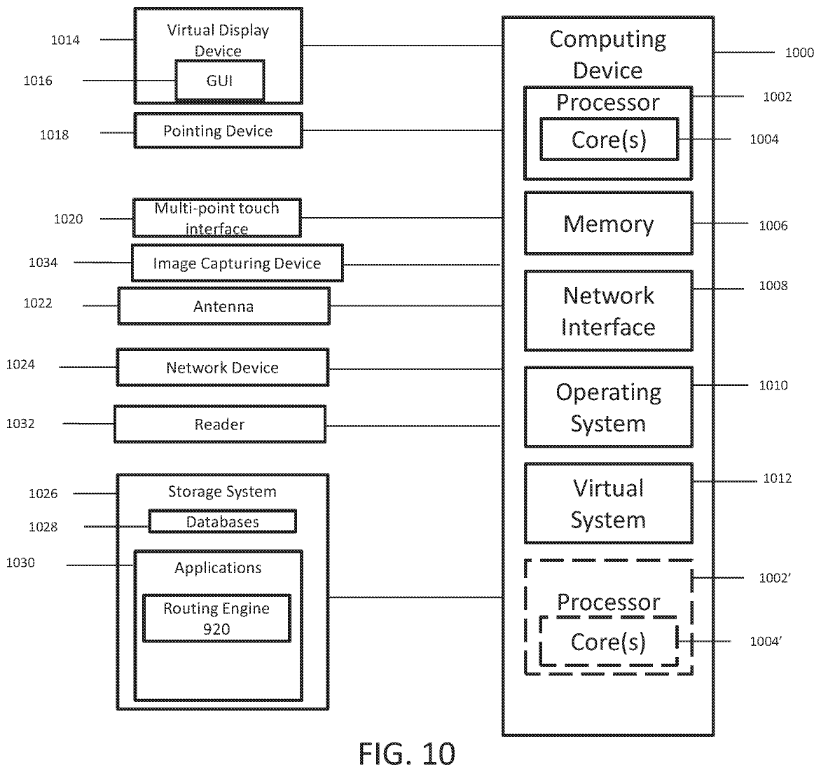

FIG. 10 is a block diagram of an example computing device for implementing exemplary embodiments of the present disclosure. The computing device 1000 may be, but is not limited to, a smartphone, laptop, tablet, desktop computer, server or network appliance. The computing device 1000 can be embodied as part of the computing system or storage tower. The computing device 1000 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 1006 included in the computing device 1000 may store computer-readable and computer-executable instructions or software (e.g., applications 1030 such as the routing engine 920) for implementing exemplary operations of the computing device 1000. The computing device 1000 also includes configurable and/or programmable processor 1002 and associated core(s) 1004, and optionally, one or more additional configurable and/or programmable processor(s) 1002′ and associated core(s) 1004′ (for example, in the case of computer systems having multiple processors/cores), for executing computer-readable and computer-executable instructions or software stored in the memory 1006 and other programs for implementing exemplary embodiments of the present disclosure. Processor 1002 and processor(s) 1002′ may each be a single core processor or multiple core (1004 and 1004′) processor. Either or both of processor 1002 and processor(s) 1002′ may be configured to execute one or more of the instructions described in connection with computing device 1000.

Virtualization may be employed in the computing device 1000 so that infrastructure and resources in the computing device 1000 may be shared dynamically. A virtual machine 1012 may be provided to handle a process running on multiple processors so that the process appears to be using only one computing resource rather than multiple computing resources. Multiple virtual machines may also be used with one processor.

Memory 1006 may include a computer system memory or random access memory, such as DRAM, SRAM, EDO RAM, and the like. Memory 1006 may include other types of memory as well, or combinations thereof.

A user may interact with the computing device 1000 through a visual display device 1014, such as a computer monitor, which may display one or more graphical user interfaces 1016, multi touch interface 1020, a pointing device 1018, an image capturing device 1034 and a scanner 1032.

The computing device 1000 may also include one or more computer storage devices 1026, such as a hard-drive, CD-ROM, or other computer-readable media, for storing data and computer-readable instructions and/or software that implement exemplary embodiments of the present disclosure (e.g., applications). For example, exemplary storage device 1026 can include one or more databases 1028 for storing information regarding physical objects and the storage towers. The databases 1028 may be updated manually or automatically at any suitable time to add, delete, and/or update one or more data items in the databases.

The computing device 1000 can include a network interface 1008 configured to interface via one or more network devices 1024 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing system can include one or more antennas 1022 to facilitate wireless communication (e.g., via the network interface) between the computing device 1000 and a network and/or between the computing device 1000 and other computing devices. The network interface 1008 may include a built-in network adapter, network interface card, PCMCIA network card, card bus network adapter, wireless network adapter, USB network adapter, modem or any other device suitable for interfacing the computing device 1000 to any type of network capable of communication and performing the operations described herein.

The computing device 1000 may run any operating system 1010, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 1000 and performing the operations described herein. In exemplary embodiments, the operating system 1010 may be run in native mode or emulated mode. In an exemplary embodiment, the operating system 1010 may be run on one or more cloud machine instances.

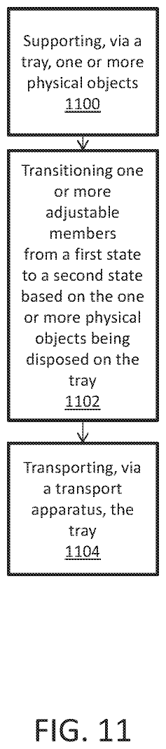

FIG. 11 is a flowchart illustrating the process of the autonomous storage and retrieval system according to exemplary embodiment. In operation 1100, a tray (e.g., tray 124 as shown in FIGS. 1-3, 5-8 and 9) can support one or more physical objects (e.g., physical object 126 as shown in FIG. 1-3, 5-8). In operation 1102, one or more adjustable members (e.g., adjustable members shown in FIGS. 5-9) coupled to the tray can transition from a first state to a second state based on the one or more physical objects disposed on the tray. The one or more adjustable members stabilize the one or more physical objects when the one or more adjustable members are in the second state. In operation 1104, a transport apparatus (e.g., transport apparatus 222 as shown in FIGS. 1 and 9) can transport the tray with the physical object from a receptacle (e.g. receptacle 100 as shown in FIG. 1 and front receptacle 212, first side receptacle 220, and second side receptacle 216 as shown in FIG. 2) of an autonomous storage and retrieval system (e.g., storage tower 200 as shown in FIGS. 1-2, and 9) to at least one of the plurality of shelves (e.g., shelving unit 302 as shown in FIGS. 3) in the autonomous storage and retrieval system to store the tray on the at least one of the plurality of shelves in the autonomous storage and retrieval system, or from the at least one of the plurality of shelves in the storage tower to the receptacle to output the one or more physical objects. The one or more adjustable members are in the second state as the transport apparatus transports the tray between the at least one of the plurality of shelves and the receptacle.

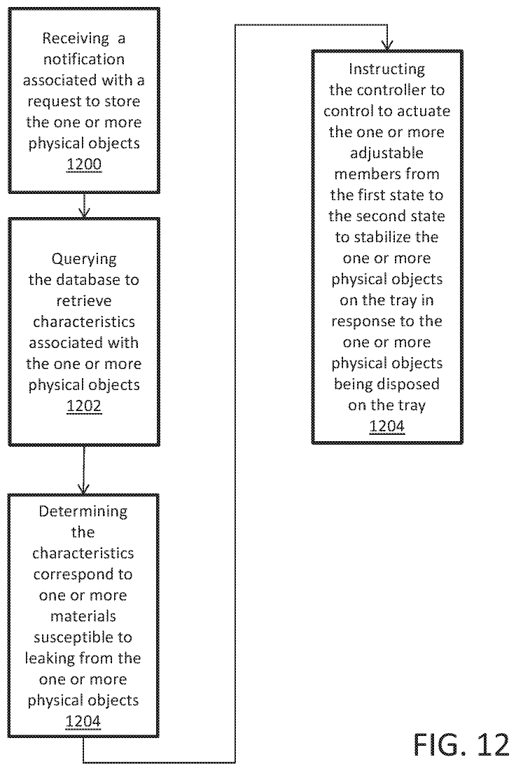

FIG. 12 is a flowchart illustrating the process of the autonomous storage and retrieval system according to exemplary embodiment. In operation 1200, a computing system (e.g., computing system 900 as shown in FIG. 9) in communication with a database and the controller (e.g., controller 942 as shown in FIG. 9), the controller coupled to the actuator (e.g., actuator 940 as shown in FIG. 9), a notification associated with a request to store or dispense the one or more physical objects (e.g. physical object 126 as shown in FIG. 1-3, 5-8) in the autonomous storage and retrieval system (e.g., storage tower 200 as shown in FIGS. 1-4, and 9). In operation 1202, the computing system can query the database (e.g. physical objects database 925 as shown in FIG. 9) to retrieve characteristics associated with the one or more physical objects. In operation 1204, the computing system can determine the characteristics correspond to one or more materials susceptible to leaking from the one or more physical objects. In operation 1206, the computing system can instruct the controller to control to actuate the one or more adjustable members (e.g., adjustable members shown in FIGS. 5-9) from the first state to the second state to stabilize the one or more physical objects on the tray in response to the one or more physical objects being disposed on the tray (e.g. tray 124 as shown in FIGS. 1-3, 5-8 and 9).

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

One or more of the exemplary embodiments, include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI is a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data. In a further exemplary embodiment, the kernel will filter out noisy data (“KRN”). In an exemplary embodiment, KRN, like KRI, includes substantially a continuously utilized near term source of data, but KRN may be retained in order to provide a predictive model of noisy data.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

We claim:

1. An autonomous storage and retrieval system, the system comprising:
a tray configured to support one or more physical objects;
one or more adjustable members operatively coupled with the tray, the one or more adjustable members configured to transition from a first state to a second state based on the one or more physical objects being disposed on the tray, the one or more physical object being stabilized by the one or more adjustable members when the one or more adjustable members are in the second state;
a plurality of shelves, at least one of the plurality of shelves being configured to support the tray;
a storage receptacle for receiving the one or more physical objects to be stored by the autonomous storage and retrieval system or for outputting the one or more physical objects from the autonomous storage and retrieval system;
a transport apparatus to transport the tray from the receptacle to the at least one of the plurality of shelves to store the tray on the at least one of the plurality of shelves in the autonomous storage and retrieval system or to transport the tray from the at least one of the plurality of shelves in the autonomous storage and retrieval system to the receptacle to output the one or more physical objects,
wherein the one or more adjustable members are in the second state as the transport apparatus transports the tray between the at least one of the plurality of shelves and the receptacle.

2. The system of claim 1, further comprising an actuator configured to control the one or more adjustable members to facilitate transition from the first state to the second state.

3. The system of claim 2, further comprising:
a controller operatively coupled to the actuator; and
a computing system in communication with a database and the controller, the computing system configured to:
receive a notification associated with a request to store or dispense the one or more physical objects in the autonomous storage and retrieval system;
query the database to retrieve characteristics associated with the one or more physical objects;
determine the characteristics correspond to one or more materials susceptible to leaking from the one or more physical objects; and
instruct the controller to control the actuator to actuate the one or more adjustable members from the first state to the second state to stabilize the one or more physical objects on the tray in response to the one or more physical objects being disposed on the tray.

4. The system of claim 3, wherein the one or more adjustable members is an inflatable bladder and the actuator is an air compressor.

5. The system of claim 4, wherein the first state correspond to the inflatable bladder in a deflated state and the second state correspond to the inflatable bladder being inflated.

6. The system of claim 3, wherein the one or more adjustable members comprises a adjustable wall and the actuator comprises an arm configured to move the adjustable wall laterally to engage the one or more physical objects when the one or more physical objects are disposed on the tray.

7. The system of claim 6, wherein in response to receiving the instruction from the computing system to control the adjustable members, the controller controls the actuator to move the adjustable wall laterally toward the physical object on the tray to clamp the one or more physical objects in a stable position.

8. The system of claim 3, wherein the one or more adjustable members comprises:
an electromagnetic element disposed on a surface of the tray and configured to selectively generate a magnetic field in response to receiving an electric current, and
wherein a ferromagnetic material is operatively coupled to the one or more physical objects.

9. The system of claim 8, wherein in response to receiving the instruction from the computing system to control the adjustable members, the actuator provides an electric current to the electromagnetic element to generate a magnetic field around the physical object.

10. The system of claim 1, wherein the one or more adjustable members comprises a plurality of spring loaded pins disposed on the tray, wherein the first state correspond to the plurality of spring loaded pins protruding into an area of the tray configured to receive the one or more physical objects and the second state corresponds to at least some of the plurality of spring loaded pins being in a retracted state prior in response to an interaction with the one or more physical objects when the one or more physical objects are placed on the tray.

11. An autonomous storage and retrieval method, the method comprising:
supporting, via a tray, one or more physical objects;
transitioning one or more adjustable members operatively coupled with the tray from a first state to a second state based on the one or more physical objects being disposed on the tray, the one or more adjustable members stabilizing the one or more physical objects when the one or more adjustable members are in the second state;
transporting, via a transport apparatus, the tray (i) from a receptacle of an autonomous storage and retrieval system to at least one of the plurality of shelves in the autonomous storage and retrieval system to store the tray on the at least one of the plurality of shelves in the autonomous storage and retrieval system or (ii) from the at least one of the plurality of shelves in the autonomous storage and retrieval system to the receptacle to output the one or more physical objects,
wherein the one or more adjustable members are in the second state as the transport apparatus transports the tray between the at least one of the plurality of shelves and the receptacle.

12. The method of claim 11, further comprising controlling, via an actuator, the adjustable member to facilitate transition from the first state to the second state.

13. The method of claim 12, further comprising:
receiving, via a computing system in communication with a database and a controller, the controller being the coupled to the actuator, a notification associated with a request to store the one or more physical objects in the autonomous storage and retrieval system;
querying, via the computing system, the database to retrieve characteristics associated with the one or more physical objects;
determining, via the computing system, the characteristics correspond to one or more materials susceptible to leaking from the one or more physical objects; and
instructing, via the computing system, the controller to control to actuate the one or more adjustable members from the first state to the second state to stabilize the one or more physical objects on the tray in response to the one or more physical objects being disposed on the tray.

14. The method of claim 13, wherein the one or more adjustable members is an inflatable bladder and the actuator is an air compressor.

15. The method of claim 14, wherein the first state corresponds to the inflatable bladder in a deflated state and the second state correspond to the inflatable bladder being inflated.

16. The method of claim 13, wherein the one or more adjustable members comprises a adjustable wall and the actuator comprises an arm configured to move the adjustable wall laterally to engage the one or more physical objects when the one or more physical objects are disposed on the tray.

17. The method of claim 16, further comprising controlling, via the controller, the controller controls the actuator to move the adjustable wall laterally toward the physical object on the tray to clamp the one or more physical objects in a stable position, in response to receiving the instruction from the computing system to control the adjustable members.

18. The method of claim 13, further comprising:
selectively generating, via an electromagnetic element included in the one or more adjustable members and disposed on a surface of the tray, a magnetic field in response to receiving an electric current,
wherein a ferromagnetic material is operatively coupled to the one or more physical objects.

19. The method of claim 18, further comprising, providing, via the actuator, an electric current to the electromagnetic element to generate a magnetic field around the physical object, in response to receiving the instruction from the computing system to control the adjustable members.

20. The method of claim 11, wherein the one or more adjustable members comprises a plurality of spring loaded pins disposed on the tray, wherein the first state correspond to the plurality of spring loaded pins protruding into an area of the tray configured to receive the one or more physical objects and the second state corresponds to at least some of the plurality of spring loaded pins being in a retracted state prior in response to tan interaction with the one or more physical objects when the one or more physical objects are placed on the tray.
